(19) United States
(12) Patent Application Publication
(10) Pub. No.: US 2011/0150317 A1
(43) Pub. Date: Jun. 23, 2011

(54) SYSTEM AND METHOD FOR AUTOMATICALLY MEASURING ANTENNA CHARACTERISTICS

(75) Inventor: Seong-Min KIM, Daejeon (KR)

(73) Assignee: ELECTRONICS AND TELECOMMUNICATIONS RESEARCH INSTITUTE, Daejeon (KR)

(21) Appl. No.: 12/970,926

(22) Filed: Dec. 16, 2010

(30) Foreign Application Priority Data
Dec. 17, 2009 (KR) 10-2009-0126265
Jul. 20, 2010 (KR) 10-2010-0070191

(51) Int. Cl. G06K 9/00

(52) U.S. Cl. 382/141

(57) ABSTRACT

An apparatus for automatically measuring characteristics of an antenna recognizes an object of the antenna based on an antenna image received from an external image capturing device, and extracts a parameter by using the recognized object of the antenna. The apparatus then authentically controls the position and direction of the image capturing device and an antenna characteristic measurement instrument by using the extracted parameter to thus automatically measure the characteristics of the antenna.

### CROSS-REFERENCE TO RELATED APPLICATION

This application claims priority to and the benefit of Korean Patent Application No. 10-2009-0126265 and 10-2010-0070191 filed in the Korean Intellectual Property Office on Dec. 17, 2009 and Jul. 20, 2010, the entire contents of which are incorporated herein by reference.

### BACKGROUND OF THE INVENTION

(a) Field of the Invention

The present invention relates a system and method for automatically measuring characteristics, and, more particularly to a system and method for automatically measuring the characteristics of an antenna by using image recognition.

(b) Description of the Related Art

As society is advancing and becoming more information-oriented, diverse wireless mobile communication techniques allowing various types of information to be freely transmitted and received any time all over the world are being developed and used.

An antenna, an essential element of a wireless mobile communication device, is widely used in all sectors ranging from various high technologies using electromagnetic waves such as radar, ECM (electronic countermeasures)/ECCM (electronic counter-countermeasures), telemetry, remote sensing, EMI (electromagnetic interference)/EMC (electromagnetic compatibility), measurement, broadcasting, radio astronomy, navigation, and the like, to daily life, as well as various types of wireless communications.

Recently, as the frequency band used by electromagnetic waves has been extending to a military wave area and development and use of high performance (gain, directionality, polarization characteristics) and highly functional antennas are required to be developed and used, the importance of accurate measurement of antenna characteristics is increasing. In addition, antennas are variably applied and the interest in measuring the antenna characteristics required for manufacturing antennas is increasing, so an antenna characteristic measurement system is required to have a higher degree of precision.

However, such antenna characteristic measurement equipment is expensive and its application field is limited, which is thus why it has been scarcely developed to be constituted as a system domestically, and even in foreign countries, some enterprises have merely developed techniques to productize it. The conventionally developed system, which is not an automated system, is based on a user's manual operation in measuring antenna characteristics.

Thus, the related art system detects a central point of the antenna based on the operator's estimation and skill level (or proficiency) and measures the polarization of radio waves and recognizes a measurement distance, causing an error.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for automatically measuring antenna characteristics.

An exemplary embodiment of the present invention provides a method for automatically measuring the characteristics of an antenna by using an antenna characteristic measurement instrument, including:

recognizing an object of an antenna based on an antenna image received from an external image capturing device; extracting a parameter by using the recognized object of the antenna; and automatically controlling the location and direction of the image capturing device and the antenna characteristic measurement instrument by using the extracted parameter to automatically measure the characteristics of the antenna.

Another embodiment of the present invention provides an apparatus for automatically measuring the characteristics of an antenna by using an antenna characteristic measurement instrument, including:

a recognition module configured to recognize an object of an antenna based on an antenna image received from an external image capturing device; an extraction module configured to extract a parameter by using the recognized object of the antenna; and a control module configured to automatically control the location and direction of the image capturing device and the antenna characteristic measurement instrument by using the extracted parameter to automatically measure the characteristics of the antenna.

### BRIEF DESCRIPTION OF THE DRAWINGS

FIG. 1 is an exemplary view showing a service environment employing a system for automatically measuring antenna characteristics according to an exemplary embodiment of the present invention.

FIG. 2 is a schematic block diagram of the system for automatically measuring antenna characteristics according to an exemplary embodiment of the present invention.

FIG. 3 is a flowchart illustrating the process of a method for automatically measuring the characteristics of an antenna according to an exemplary embodiment of the present invention.

FIG. 4 is a flowchart illustrating the process of recognizing an antenna object according to an exemplary embodiment of the present invention.

FIG. 5 is a flowchart illustrating a process of binarizing an image in a process of recognizing an object of an antenna according to an exemplary embodiment of the present invention.

FIG. 6 is a flowchart illustrating a process of selecting a central object in a process of recognizing an object of an antenna according to an exemplary embodiment of the present invention.

FIG. 7 is a flowchart illustrating a process of extracting a parameter according to an exemplary embodiment of the present invention.

FIG. 8 is a schematic block diagram showing the configuration of a control module according to an exemplary embodiment of the present invention.

FIG. 9 is a flowchart illustrating the process of a method for controlling a camera and an antenna characteristic measurement instrument according to an exemplary embodiment of the present invention.

FIG. 10 is a flowchart illustrating the process of a method for controlling a camera according to an exemplary embodiment of the present invention.

FIG. 11 is a flowchart illustrating the process of a method for controlling an antenna characteristic measurement instrument according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A system and method for automatically measuring antenna characteristics according to an exemplary embodiment of the present invention will now be described in detail with reference to the accompanying drawings.

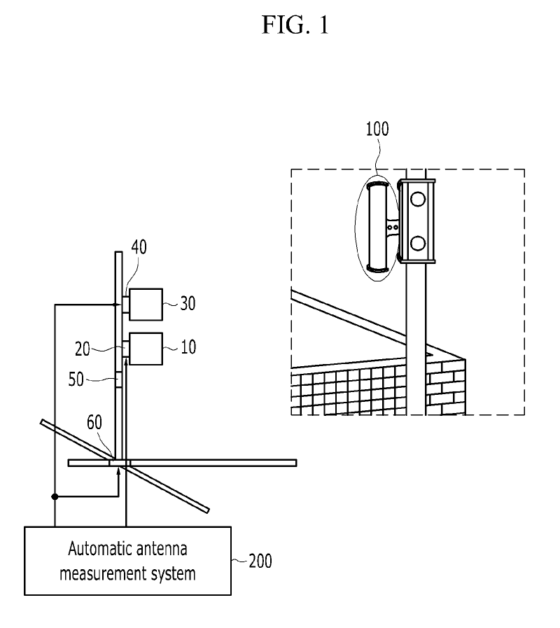

FIG. 1 is an exemplary view showing a service environment employing a system for automatically measuring antenna characteristics according to an exemplary embodiment of the present invention.

First, a system for automatically measuring antenna characteristics according to an exemplary embodiment of the present invention is a system for recognizing a measurement distance for measuring radiated power in a Fresnel zone.

As shown in FIG. 1, a service environment according to an exemplary embodiment of the present invention includes a camera 10, a first control motor 20, a measurement instrument 30, a second control motor 40, a third control motor 50, a fourth control motor 60, and an automatic antenna characteristic measurement system 200. Here, the first to fourth control motors 20, 40, 50, and 60 according to an exemplary embodiment of the present invention may be step motors or any other motors, and the present invention is not limited thereto.

The camera 10 captures an image of an antenna 100 and delivers the captured antenna image to the automatic antenna characteristic measurement system 200.

The first control motor 200 controls the camera 10 according to a control signal delivered from the automatic antenna characteristic measurement system 200.

The antenna characteristic measurement instrument 30 measures the characteristics of the antenna 100.

The second control motor 40 controls the antenna characteristic measurement instrument 30.

The third control motor 50 corrects the camera 10 and the antenna characteristic measurement instrument 30 in a vertical direction.

The fourth control motor 60 adjusts a horizontal distance of the antenna 100, the camera 10, and the antenna characteristic measurement instrument 30 according to a control signal delivered from the automatic antenna characteristic measurement system 200.

The automatic antenna characteristic measurement system 200 extracts an object of the antenna based on an antenna image, and extracts a parameter by using the recognized object of the antenna. Next, the automatic antenna characteristic measurement system 200 automatically controls the location and direction of the camera 10 and the antenna characteristic measurement instrument 30 by using the extracted parameter.

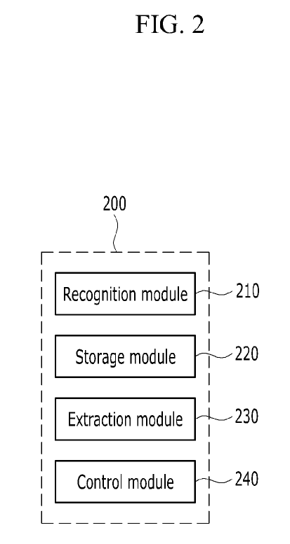

The automatic antenna characteristic measurement system 200 will now be described in detail with reference to FIG. 2.

FIG. 2 is a schematic block diagram of the system for automatically measuring antenna characteristics according to an exemplary embodiment of the present invention.

As shown in FIG. 2, the automatic antenna characteristic measurement system 200 includes a recognition module 210, a storage module 220, an extraction module 230, and a control module 240.

The recognition module 210 recognizes the object of the antenna based on the received antenna image. In detail, the recognition module 210 is installed at a location at which the recognition module 210 faces the characteristic measurement target antenna, and extracts a central antenna image from the antenna image.

The storage module 220 stores basic antenna information corresponding to the antenna. Here, the basic antenna information is information that has been obtained by previously measuring and processing information related to the antenna required for extracting the parameter and storing the same. For example, the storage module 220 stores attributes and data formats of the basic antenna information as shown in Table 1 below.

TABLE 1

| Attribute | Data format |
|---|---|
| Antenna category | Number |
| Antenna name | String |
| Model No. | Number |
| Cb Threshold value_upper limit value | Number |
| Cb Threshold value_lower limit value | Number |
| Cr Threshold value_upper limit value | Number |
| Cr Threshold value_lower limit value | |
| Shape information | String |
| Number of corner points | Number |
| Moment | |
| Radiated power location information | Number |
| (x, y) | |

The extraction module 230 extracts a parameter by using the recognized object of the antenna. Here, the parameter according to an exemplary embodiment of the present invention is a variable required for automatically measuring the characteristics of the antenna, which may include a central point, an angle, and the like, of the antenna, and the present invention is not limited thereto.

The control module 240 automatically controls the position and direction of the camera 10 and the antenna characteristic measurement instrument 30 by using the extracted parameter.

In detail, the control module 240 verifies the variable and calculates a control parameter for moving to a line-of-sight (LOS) of the antenna characteristic measurement instrument 30 by using the verified parameter and the LOS of the storage module 220. In this case, the control module 240 changes the position of the camera 10 and changes the camera to verify the parameter based on whether or not the antenna image is detected at the center to the front.

The control module 240 then moves or rotates the antenna characteristic measurement instrument 30 based on the control parameter.

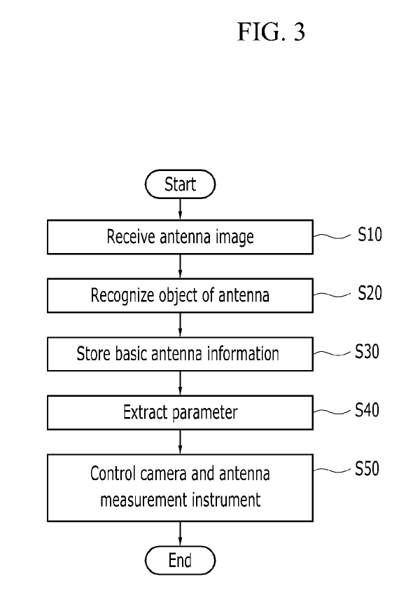

A method for automatically measuring the characteristics of an antenna according to an exemplary embodiment of the present invention will now be described in detail with reference to FIG. 3.

FIG. 3 is a flowchart illustrating the process of a method for automatically measuring the characteristics of an antenna according to an exemplary embodiment of the present invention.

As shown in FIG. 3, a system 200 for automatically measuring antenna characteristics receives an antenna image captured by the camera 10 (S10).

The system 200 for automatically measuring antenna characteristics recognizes an object of the antenna based on the received antenna image (S20).

The system 200 for automatically measuring antenna characteristics stores information related to the antenna required for extracting a parameter, that is, basic antenna information (S30). Here, the parameter may be a variable required for automatically measuring the characteristics of the antenna.

The system 200 for automatically measuring antenna characteristics extracts the parameter by using the recognized object of the antenna (S40).

The system 200 for automatically measuring antenna characteristics automatically controls the position and direction of the camera 10a and the antenna characteristic measurement instrument 30 by using the extracted parameter.

Thus, the system 200 for automatically measuring antenna characteristics according to an exemplary embodiment of the present invention is able to automatically measure the characteristics of the antenna by automatically controlling the camera 10 and the antenna characteristic measurement instrument 30.

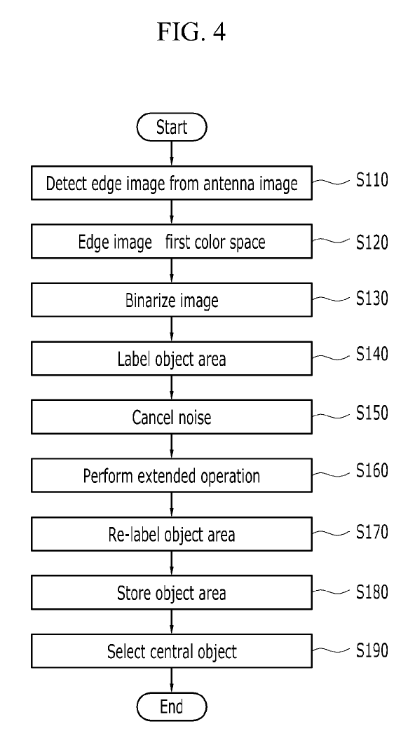

The process of recognizing an object of the antenna by the recognition module 210 will now be described in detail with reference to FIG. 4.

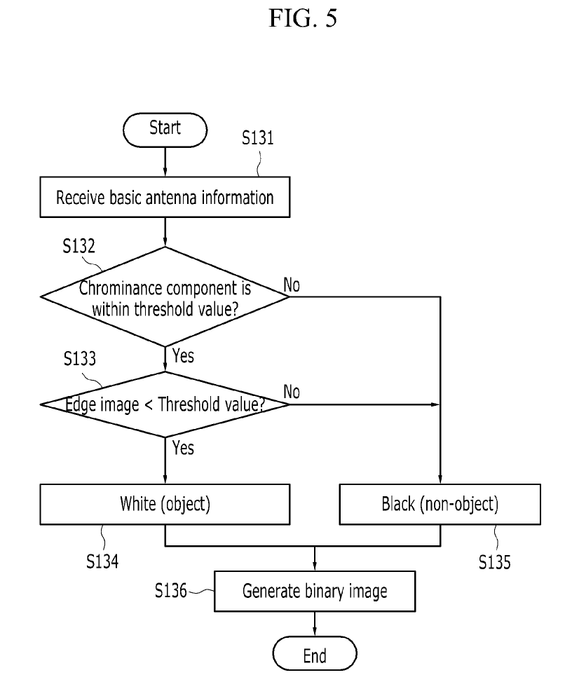

FIG. 4 is a flowchart illustrating the process of recognizing an antenna object according to an exemplary embodiment of the present invention. FIG. 5 is a flowchart illustrating a process of binarizing an image in the process of recognizing an object of an antenna according to an exemplary embodiment of the present invention.

As shown in FIG. 4, the recognition module 210 detects an edge image from the antenna image captured by the camera 10 (S110).

The recognition module 210 converts the detected edge image into a particular color space (S120). Here, the particular color space is a YCbCr color space. The YCbCr color space is a type of color space, of which Y is a luminance component and Cb and Cr are chrominance components. The [Equation 1]

Y=0.29900R+0.58700G+0.11400B

Cb=−0.16874R−0.33126G+0.50000B

Cr=0.50000R−0.41869G−0.08131B

In general, the antenna has various shapes and colors regardless of various internal structures thereof. The antenna has values of certain ranges in the chrominance components Cb and Cr. That is, the recognition module 210 according to an exemplary embodiment of the present invention detects the shape of the antenna by using the chrominance components Cb and Cr of the YCbCr color space.

The recognition module 210 binarizes the edge image according to a range value of each antenna by using the chrominance components Cb and Cr (S130). When an image is captured, there is an occasion where the edge image is dim due to an influence such as illumination, reflection, and the like. Thus, the recognition module 210 binarizes the edge image in consideration thereof.

The process of binarizing an image in the process of recognizing an object of the antenna will now be described in detail with reference to FIG. 4.

As shown in FIG. 5, the recognition module 210 receives basic antenna characteristic information corresponding to the antenna from the storage module 220 (S131).

The recognition module 210 determines whether or not the chrominance components Cb and Cr are positioned in an area within a corresponding threshold value (S132). When the chrominance components Cb and Cr are within the corresponding threshold value, the recognition module 210 determines whether or not the edge image is smaller than the corresponding threshold value (S133).

When the edge image is smaller than the corresponding threshold value, the recognition module 210 determines that the edge image corresponds to white, that is, to an object area (S134).

Meanwhile, when the chrominance components Cb and Cr are not positioned within the corresponding threshold value or when the edge image is greater than the corresponding threshold value, the recognition module 210 determines that the edge image corresponds to black, that is, to a non-object area (S135).

The recognition module then generates a binary image by using the object area and the non-object area (S136).

The process of binarizing the edge image by the recognition module 210 is represented by Equation 2 shown below.

$$B ( x , y ) = \{ \begin{matrix}255 , & \begin{matrix}{TH}_{l 1} \leq Cr \leq {Th}_{h 1} \\ {Th}_{l 2} \leq Cb \leq {Th}_{h 2} \\ Edge < {Th}_{e}\end{matrix} \\ 0 , & Other\end{matrix} \qquad [ Equation 2 ]$$

Here, (x,y) is coordinates of a pixel, and Thₗ₁, Thₕ₁, Thₗ₂, and Thₕ₂ are upper and lower threshold values of the threshold values of the chrominance components Cb and Cr. Thₑ is a threshold value of the edge image, 255 is the object area, and 0 is the non-object area.

As shown in FIG. 4, the recognition module 210 labels the results obtained by binarizing the edge image, that is, the object area corresponding to the binary image, to obtain an antenna candidate object area (S140). In this case, holes or the like exist in the candidate object area due to noise and illumination. Thus, the recognition module 210 cancels noise (S150) and performs an extended operation to re-generate the object area (S160). In this case, the method of canceling noise by the recognition module 210 may be performed by using an average filter, a median filter, or the like, which are used for image processing, and may include a method of canceling a small area by limiting the size of the area in order to remove the small area.

The recognition module 210 re-labels the regenerated object area to extract an object candidate area (S170) and store the regenerated object area (S180).

The recognition module 210 selects an area most similar to the regenerated object area of the extracted object candidate area as a central object (S190). In this case, the central object may have various shapes depending on the type of the antenna.

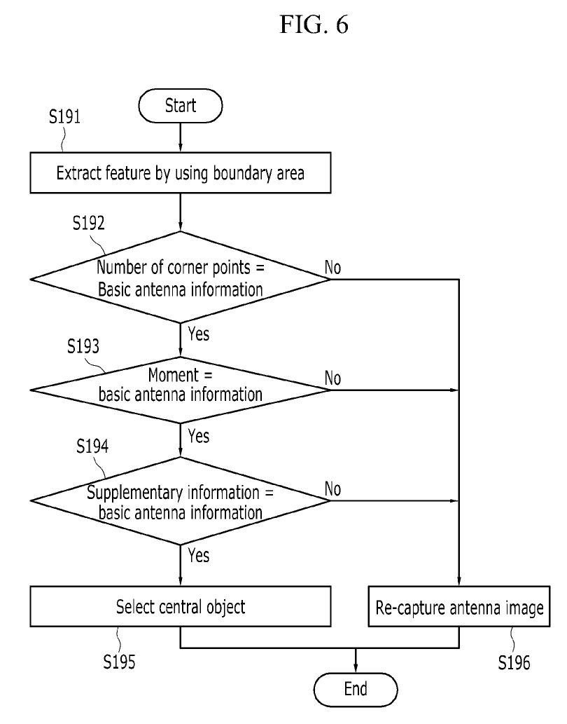

The process of selecting the central object in the process of recognizing the object of the antenna will now be described in detail with reference to FIG. 6.

FIG. 6 is a flowchart illustrating a process of selecting a central object in the process of recognizing an object of an antenna according to an exemplary embodiment of the present invention.

As shown in FIG. 6, the recognition module 210 extracts a corner point, shape information, a moment, supplementary information, and the like (S191).

The recognition module 210 determines whether or not the number of extracted corner points is identical to basic antenna characteristic information included in the storage module 220 (S192). When the number of extracted corner points and the basic antenna characteristic information are identical, the recognition module 210 determines whether or not the extracted moment is identical to the basic antenna characteristic information included in the storage module 220 (S193). When the extracted moment is identical to the basic antenna characteristic information, the recognition module 210 determines whether or not the extracted supplementary information is identical to the basic antenna characteristic information included in the storage module 220 (S194).

When both the extracted information and the basic antenna characteristic information are identical, the recognition module 210 selects the area most similar to the object area as a central object (S195).

When the extracted information and the basic antenna characteristic information are not identical, the recognition module 210 determines that the antenna image to be selected as a central object has been erroneously selected or determines that an antenna image has failed to be detected, and controls the camera 10 to perform re-capturing.

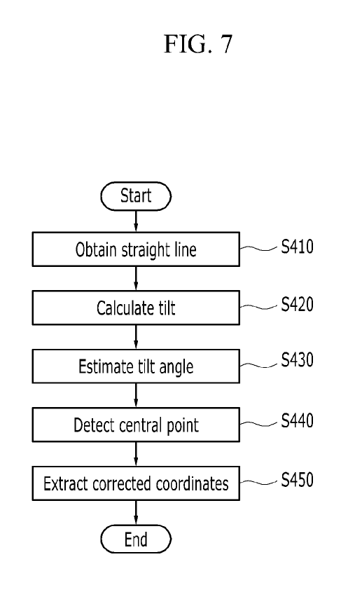

The process of extracting a parameter by using a recognized object of the antenna will now be described in detail with reference to FIG. 7.

FIG. 7 is a flowchart illustrating a process of extracting a parameter according to an exemplary embodiment of the present invention.

First, a parameter according to an exemplary embodiment of the present invention includes an angle for measuring tilting of the antenna, central coordinates for moving to a line-of-sight (LOS) of the antenna characteristic measurement instrument 30, and the like.

As shown in FIG. 7, the extraction module 230 secures an area to become a straight line with the antenna, extracts a corner point, and obtains a straight line based on the extracted corner point (S410).

For example, the extraction module 230 estimates the position of a straight line by using the basic antenna characteristic information, and obtains a straight line by using the estimated position of a straight line and outline information of the antenna object. Here, the outline information of the object may be an inexact straight line rather than a straight line due to ambient noise or other influences.

Thus, as for the outline information of the object, the slope and y-intercept of an equation of an approximated straight line of the inexact straight line are obtained by a linear regression equation.

The extraction module 230 stores all the x and y coordinates present in the segment of the straight line in the variable and then obtains the slope and the y-intercept value of the straight line (S420). Here, the slope and the y-intercept value are obtained as represented by Equation 3 shown below:

$$y = ax + b \\ a = \overline{y} - b \overline{x} \\ b = \frac{n {\sum }_{i = 1}^{n} {x}_{i} {y}_{i} - {\sum }_{i = 1}^{n} {x}_{i} {\sum }_{i = 1}^{n} {y}_{i}}{n {\sum }_{i = 1}^{n} {x}_{i}^{2} - {( {\sum }_{i = 1}^{n} {x}_{i} )}^{2}} \qquad [ Equation 3 ]$$

Here, a is the slope, b is the y-intercept, and xᵢ, yᵢ is the outermost coordinates of vertical and horizontal portions of a quadrangle, respectively, which includes n number of coordinates.

The extraction module 230 estimates an angle corresponding to the tilting degree as to how much the slope has been rotated by using the equation of the straight line (S430). Here, the angle may be obtained by using the slope of the antenna image. For example, when the slope of the antenna image is assumed to be “a”, the tilting angle is α=tan⁻¹(α).

After estimating the angle, the extraction module 230 detects a central point by using the extracted corner point and the extracted primary moment (S440).

Here, the moment is the gauge of a distribution of values based on a particular axis. Also, the moment is a scalar quantity, which corresponds to the characteristics of describing a target object in pattern recognition or pattern interpretation. A (p+q)-th moment of the antenna image (f(x,y)) according to an exemplary embodiment of the present invention is obtained as represented by Equation 4 shown below.

$${m}_{pq} = {\sum }_{x} {\sum }_{y} {x}^{p} {y}^{q} f ( x , y ) \qquad [ Equation 4 ]$$

For example, in the case of the binary image, the moment is 1 within the target object and 0 in a background. As shown in Equation 4, a 0^{th} moment m₀₀ of the binary image is the total of f(x,y), which is equal to the area.

Thereafter, the extraction module 230 normalizes the primary moments m₁₀, m₀₁ with m₀₀ to extract mass center coordinates, that is, central points, as represented by Equation 5 shown below.

$${x}_{c} = \frac{{m}_{10}}{{m}_{00}} , {y}_{c} = \frac{{m}_{01}}{{m}_{00}} \qquad [ Equation 5 ]$$

When the center of the camera, that is, the extracted central point, is (x_{c}, y_{c}) and the center (xₜ, yₜ) of the antenna are not identical, the extraction module 230 obtains a difference value of each of x and y and obtain corrected coordinates of the antenna (S450). Here, the corrected coordinates can be obtained as represented by Equation 6 shown below.

Δx=x_{c}−xₜ

Δy=y_{c}−yₜ [Equation 6]

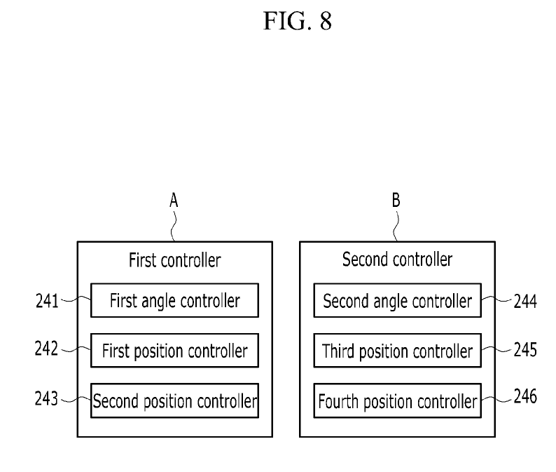

The control module 240 of the system 200 for automatically measuring antenna characteristics will now be described in detail with reference to FIG. 8.

FIG. 8 is a schematic block diagram showing the configuration of a control module according to an exemplary embodiment of the present invention.

As shown in FIG. 8, the control module 240 includes a first controller (A) for controlling the camera 10 and a second controller (B) for controlling the antenna characteristic measurement instrument 30.

The first controller (A) includes a first angle controller 241 for controlling the angle of the camera 10, a first position controller 242 for controlling a vertical position of the camera 10, and a second position controller 243 for controlling a horizontal position of the camera 10.

The second controller (B) includes a second angle controller 244 for controlling the angle of the antenna characteristic measurement instrument 30, a third position controller 245 for controlling a vertical position of the antenna characteristic measurement instrument 30, and a fourth position controller 246 for controlling a horizontal position of the antenna characteristic measurement instrument 30.

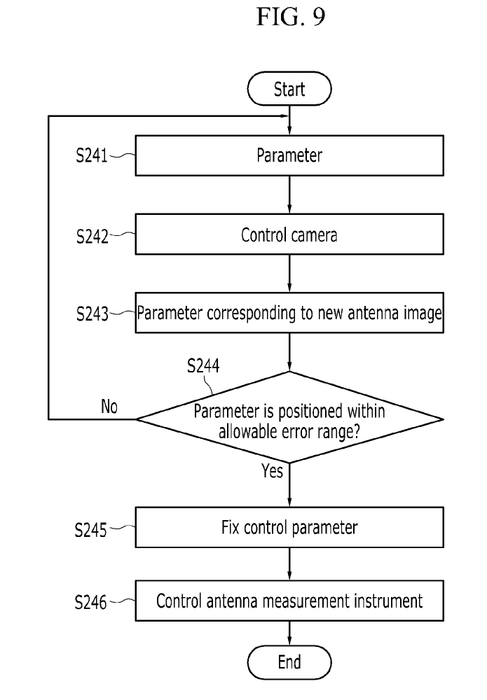

A method for controlling the camera 10 and the antenna characteristic measurement instrument 30 by the control module 240 will now be described in detail with reference to FIG. 9.

FIG. 9 is a flowchart illustrating the process of a method for controlling a camera and an antenna characteristic measurement instrument according to an exemplary embodiment of the present invention.

As shown in FIG. 9, the control module 240 receives the parameter from the extraction module 230 (S241). Here, the parameter may include the coordinates of a central point, angle corrected coordinates, and the like of the antenna.

The control module 240 rotates the camera and moves the position of the camera by using the angle and the corrected coordinates (S242).

The control module 240 receives a new antenna image from the moved camera 10 to thus receive a corresponding new parameter (S243).

The control module 240 checks whether or not the received new parameter is within an allowable error range (or a margin of error) (S244).

When the new parameter is within the allowable error range, the control module 240 fixes the angle and the corrected coordinates that have been used for correcting the camera 10, as control parameters of the antenna characteristic measurement instrument 30 (S245). When the new parameter is not within the allowable error range, the control module 240 receives a parameter again.

The control module 240 controls the antenna characteristic measurement instrument 30 by using the fixed control parameters (S246).

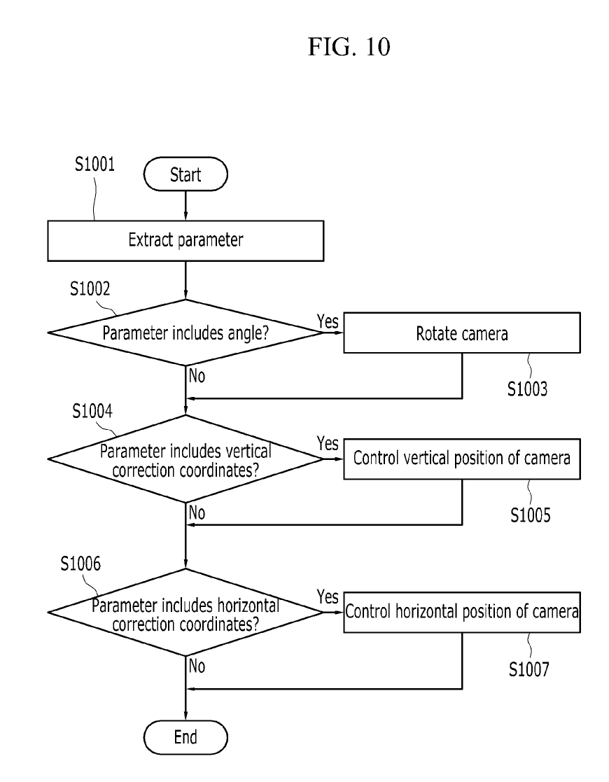

A method for controlling the camera 10 based on the method for automatically measuring an antenna will now be described in detail with reference to FIG. 10.

FIG. 10 is a flowchart illustrating the process of a method for controlling a camera according to an exemplary embodiment of the present invention.

As shown in FIG. 10, the system 200 for automatically measuring antenna characteristics extracts a parameter corresponding to an antenna image captured by the camera 10 (S1001).

The system 200 for automatically measuring antenna characteristics determines whether or not the extracted parameter includes an angle for measuring tilting of the antenna (S1002).

When the parameter includes the angle, the system 200 for automatically measuring antenna characteristics correspondingly drives the control motor 20 according to the angle to rotate the camera 10 (S1003).

When the parameter does not include the angle, the system 200 for automatically measuring antenna characteristics determines whether or not the parameter includes vertical correction coordinates (S1004).

When the parameter includes the vertical correction coordinates, the system 200 for automatically measuring antenna characteristic correspondingly controls the third control motor 50 according to the vertical correction coordinates to move the camera 10 in a vertical direction (S1005).

When the parameter does not include the vertical correction coordinates, the system 200 for automatically measuring antenna characteristics determines whether or not the parameter includes horizontal correction coordinates (S1006).

When the parameter includes the horizontal correction coordinates, the system 200 for automatically measuring antenna characteristics correspondingly controls the fourth control motor 60 according to the horizontal correction coordinates to move the camera 10 in a horizontal direction to align the central point (S1007).

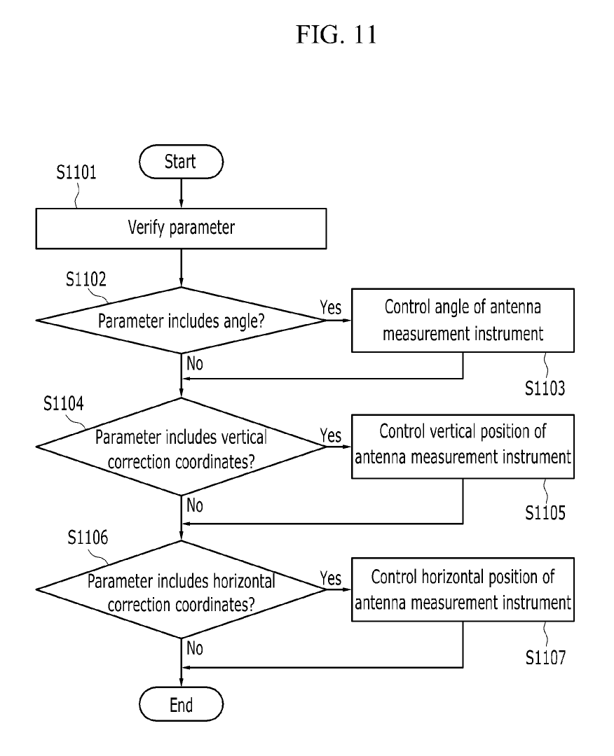

A method for controlling the antenna characteristic measurement instrument 30 based on the method for automatically measuring antenna characteristics will now be described in detail with reference to FIG. 11.

FIG. 11 is a flowchart illustrating the process of a method for controlling the antenna characteristic measurement instrument according to an exemplary embodiment of the present invention.

As shown in FIG. 11, the system 200 for automatically measuring antenna characteristics receives a new antenna image from the moved camera 10, verifies a corresponding new parameter, and fixes it as a control parameter (S1101). Here, a line-of-sight (LOS) may vary depending on the type of antennas. The system 200 for automatically measuring antenna characteristics obtains corrected coordinates of the antenna as represented by Equation 7 shown below by using a difference value with the central point (x_{c}, y_{c}) of the camera 10 based on the LOS (xₗ, yₗ) included in the storage module 220.

Δx=xₗ−x_{c}

Δy=yₗ−y_{c} (Equation 7)

The system 200 for automatically measuring antenna characteristics determines whether or not the control parameter includes an angle for measuring tilt of the antenna (S1102).

When the control parameter includes the angle, the system 200 for automatically measuring antenna characteristics correspondingly drives the second control motor 40 according to the angle to rotate the antenna characteristic measurement instrument 30 (S1203).

When the control parameter does not include the angle, the system 200 for automatically measuring antenna characteristics determines whether or not the parameter includes vertical correction coordinates (S1104).

When the parameter includes the vertical correction coordinates, the system 200 for automatically measuring antenna characteristics correspondingly controls the third control motor 50 according to the vertical correction coordinates to move the antenna characteristic measurement instrument 30 in a vertical direction (S1105).

When the parameter does not include the vertical correction coordinates, the system 200 for automatically measuring antenna characteristics determines whether or not the parameter includes horizontal correction coordinates (S1106).

When the parameter includes the horizontal correction coordinates, the system 200 for automatically measuring antenna characteristics correspondingly controls the fourth control motor 60 according to the horizontal correction coordinates to align the central point (S1107).

According to an embodiment of the present invention, the characteristics of an antenna can be automatically measured by automatically controlling and driving a camera and an antenna characteristic measurement instrument by using image recognition. In addition, a system for automatically measuring antenna characteristics can effectively reduce a measurement error.

The exemplary embodiments of the present invention as described so far are not implemented only through a device or a method but may be implemented through a program that can realize a function corresponding to the configuration of the exemplary embodiments of the present invention or a recording medium storing the program, and such implementations may be easily made by a skilled person in the art to which the present invention pertains from the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for automatically measuring characteristics of an antenna by using an antenna characteristic measurement instrument, the method comprising:
recognizing an object of an antenna based on an antenna image received from an external image capturing device;
extracting a parameter by using the recognized object of the antenna; and
automatically controlling the location and direction of the image capturing device and the antenna characteristic measurement instrument by using the extracted parameter to automatically measure the characteristics of the antenna.

2. The method of claim 1, further comprising:
recognizing the object of the antenna;
detecting an edge image from the antenna image;
converting the edge image into a particular color space;
binarizing the edge image by using a particular component of the particular color space;
labeling an object area corresponding to binarized results to obtain a candidate object area of the antenna;
canceling noise present in the candidate object area and performing an expansion calculation to regenerate an object area; and
labeling the regenerated object area to extract an object candidate area, and selecting a portion of the object candidate area most similar to the regenerated object area as a central object.

3. The method of claim 2, wherein the binarizing of the edge image comprises:
determining whether or not a particular component is positioned in an area within a corresponding threshold value;
when the particular component is positioned within the corresponding threshold value, determining whether or not an edge image is smaller than the corresponding threshold value.
when the edge image is smaller than the corresponding threshold value, determining that the edge image corresponds to the object area; and
when the particular component is not positioned within the corresponding threshold value or when the edge image is larger than the corresponding threshold value, determining that the edge image corresponds to a non-object area.

4. The method of claim 2, wherein the selecting of the portion of the object candidate area most similar to the regenerated object area, as a central object, comprises:
extracting information including at least one of a corner point, a moment, and supplementary information by using the object area;
determining whether or not the extracted information is identical to basic information of the antenna;
when the extracted information is identical to the basic information of the antenna, selecting the portion similar to the object area, as a central object; and
when the extracted information is not identical to the basic information of the antenna, re-receiving the antenna image from the image capturing device.

5. The method of claim 1, wherein the extracting of the parameter comprises:
securing an area to become a straight line with the antenna to extract a corner point to obtain a straight line based on the corner point;
storing first and second coordinates present in a segment of the straight line, in a variable, and obtaining an equation of the straight line;
estimating an angle based on the equation of the straight line;
detecting a central point by using the corner point and the moment corresponding to the gauge of a distribution of values based on a particular axis; and
obtaining corrected coordinates of the antenna by comparing the central point and the center of the antenna.

6. The method of claim 5, wherein the automatically measuring of the characteristics of the antenna comprises:
rotating or moving the image capturing device by using the angle and the corrected coordinates;
receiving a new antenna image from the moved image capturing device and extracting a new parameter corresponding to the received new antenna image;
when the new parameter is within an allowable error range, fixing the new parameter as a control parameter of the antenna characteristic measurement instrument;
controlling the antenna characteristic measurement instrument with the control parameter; and
automatically measuring the characteristics of the antenna by using the moved image capturing device and the controlled antenna characteristic measurement instrument.

7. An apparatus for automatically measuring the characteristics of an antenna by using an antenna characteristic measurement instrument, the apparatus comprising:
a recognition module configured to recognize an object of an antenna based on an antenna image received from an external image capturing device;
an extraction module configured to extract a parameter by using the recognized object of the antenna; and
a control module configured to automatically control the location and direction of the image capturing device and the antenna characteristic measurement instrument by using the extracted parameter to automatically measure the characteristics of the antenna.

8. The apparatus of claim 7, wherein the extraction module extracts a parameter including a central point, an angle, and corrected coordinates of the antenna.

9. The apparatus of claim 7, wherein the control module verifies the parameter, calculates the control parameter for shifting the antenna characteristic measurement instrument to a line-of-sight (LOS) by using the verified parameter and the LOS, and controls the antenna characteristic measurement instrument based on the control parameter.

10. The apparatus of claim 9, wherein the control module controls the image capturing device by using the parameter.

11. The apparatus of claim 7, wherein the recognition module is provided to a position at which the recognition module faces the antenna.

12. The apparatus of claim 7, further comprising
a storage module configured to previously measure or process information regarding the antenna required for extracting the parameter, and to store the same.
